(19) United States
(12) Patent Application Publication
(10) Pub. No.: US 2008/0166155 A1
(43) Pub. Date: Jul. 10, 2008

(54) ELECTRO-OPTICAL DEVICE, IMAGE-FORMING APPARATUS, AND METHOD FOR PRODUCING ELECTRO-OPTICAL DEVICE

(75) Inventor: Tatsuaki FUNAMOTO, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/953,310

(22) Filed: Dec. 10, 2007

(30) Foreign Application Priority Data
Jan. 10, 2007 (JP) 2007-002041

(51) Int. Cl. G02B 7/04; G03G 15/04

(52) U.S. Cl. 399/218; 359/813

(57) ABSTRACT

An electro-optical device includes an electro-optical panel including a substrate and a plurality of electro-optical elements arranged on the substrate, a converging lens that converges a light beam emitted from the electro-optical panel, and a light-transmitting member interposed between the electro-optical panel and the converging lens. A first surface of the light-transmitting member opposing the converging lens is rotated about an axis along which the electro-optical elements are arranged on the substrate.

### BACKGROUND

1. Technical Field

The present invention relates to electro-optical devices including electro-optical panels on which electro-optical elements are arranged, methods for producing the electro-optical devices, and image-forming apparatuses including the electro-optical devices.

2. Related Art

To date, some structures in which converging lens arrays that converge light beams emitted from electro-optical elements are disposed between electro-optical panels including the electro-optical elements arranged thereon and image-bearing members (for example, photosensitive drums) of image printing apparatuses of the electrophotographic type have been used to form electrostatic latent images on the image-bearing members. For example, JP-A-2006-218848 describes a technology for improving the efficiency of light utilization in such a structure by interposing a light-transmitting member between an electro-optical panel and a converging lens array such that the rate of light emitted from electro-optical elements and entering the converging lens array is increased.

However, in the technology including such a light-transmitting member as described in JP-A-2006-218848, the distance between the electro-optical panel and the converging lens array is adjusted by changing the thickness of the light-transmitting member interposed therebetween. At this moment, the optical characteristics of components such as the converging lens array can vary depending on, for example, variations generated during production, and the thickness of the light-transmitting member needs to be changed depending on the optical characteristics of the components. Accordingly, many hours are required for, for example, preparing light-transmitting members with various thicknesses and selecting and placing a light-transmitting member with an optimum thickness. Moreover, the preparation of the light-transmitting members with various thicknesses disadvantageously leads to an increase in cost.

### SUMMARY

An electro-optical device according to an aspect of the invention includes an electro-optical panel including a substrate and a plurality of electro-optical elements arranged on the substrate, a converging lens that converges a light beam emitted from the electro-optical panel, and a light-transmitting member interposed between the electro-optical panel and the converging lens. A first surface of the light-transmitting member opposing the converging lens is rotated about an axis along which the electro-optical elements are arranged on the substrate.

With this structure, the distance between the electro-optical panel and the converging lens can be changed by changing the position of the converging lens disposed on the inclined surface serving as the first surface in the tilting direction of the inclined surface. Accordingly, the distance between the electro-optical panel and the converging lens can be adjusted by adjusting the position of the converging lens on the inclined surface in accordance with the optical characteristics of the components such as the converging lens without, preparing light-transmit ting members with various thicknesses. Thus, the electro-optical panel, the light-transmitting member, and the converging lens can be arranged in an optimum positional relationship without using light-transmitting members with various thicknesses. This can lead to a reduction in cost since light-transmitting members with various thicknesses are not required.

In the above-described electro-optical device, the converging lens can be joined to the light-transmitting member at the first surface of the light-transmitting member, and the electro-optical panel can be joined to the light-transmitting member at a second surface of the light-transmitting member opposing the electro-optical panel.

In the above-described electro-optical device, the position of the converging lens can be adjusted on the first surface of the light-transmitting member in the tilting direction of the first surface.

An electro-optical device according to another aspect of the invention includes an electro-optical panel including a substrate and a plurality of electro-optical elements arranged on the substrate, a converging lens that converges a light beam emitted from the electro-optical panel, and a first light-transmitting member and a second light-transmitting member interposed between the electro-optical panel and the converging lens. A first surface of the first light-transmitting member opposing the second light-transmitting member and a first surface of the second light-transmitting member opposing the first light-transmitting member are parallel to each other, and are rotated about an axis along which the electro-optical elements are arranged on the substrate.

With this structure, the total thickness of the light-transmitting members disposed on each other can be changed by changing the overlapping positions of the light-transmitting members in the tilting direction of the first surfaces. The distance between the electro-optical panel and the converging lens can be changed by changing the total thickness of the light-transmitting members as described above. Accordingly, the distance between the electro-optical panel and the converging lens can be adjusted by changing the overlapping positions of the first and second light-transmitting members in accordance with the optical characteristics of the components such as the converging lens without preparing light-transmitting members with various thicknesses. Thus, the electro-optical panel, the light-transmitting members, and the converging lens can be arranged in an optimum positional relationship without using light-transmitting members with various thicknesses. This can lead to a reduction in cost since light-transmitting members with various thicknesses are not required.

In the above-described electro-optical device, the first and second light-transmitting members can be joined to each other at the first surfaces thereof, the converging lens can be joined to the first light-transmitting member at a second surface of the first light-transmitting member opposing the converging lens, and the electro-optical panel can be joined to the second light-transmitting member at a second surface of the second light-transmitting member opposing the electro-optical panel.

In the above-described electro-optical device, the positions of the first and second light-transmitting members can be adjusted by changing the contact positions of the first surfaces of the first and second light-transmitting members in the tilting direction of the first surfaces.

In the above-described electro-optical device, the cross sections of the first and second light-transmitting members orthogonal to the axis along which the electro-optical elements are arranged can be substantially the same.

In the above-described electro-optical device, the cross sections of the first and second light-transmitting members orthogonal to the axis along which the electro-optical elements are arranged can be substantially wedge-shaped.

An image-forming apparatus according to another aspect of the invention includes an image-bearing member on which a latent image is formed when the image-bearing member is exposed to light, the above-described electro-optical device exposing the image-bearing member to light, and a developing unit that forms a developed image by applying a developer to the latent image on the image-bearing member.

A method for producing the above-described electro-optical device according to another aspect of the invention includes adjusting the position of the converging lens on the first surface of the light-transmitting member in the tilting direction of the first surface, joining the converging lens to the light-transmitting member at the first surface of the light-transmitting member, and joining the electro-optical panel to the light-transmitting member at a second surface of the light-transmitting member opposing the electro-optical panel.

A method for producing the above-described electro-optical device according to another aspect of the invention includes adjusting the positions of the first and second light-transmitting members by changing the contact positions of the first surfaces of the first and second light-transmitting members in the tilting direction of the first surfaces, joining the first and second light-transmitting members to each other at the first surfaces thereof, joining the converging lens to the first light-transmitting member at a second surface of the first light-transmitting member opposing the converging lens, and joining the electro-optical panel to the second light-transmitting member at a second surface of the second light-transmitting member opposing the electro-optical panel.

### BRIEF DESCRIPTION 0F THE DRAWINGS

The invention will be described with reference to the accompanying drawings, wherein like numbers reference like elements.

FIG. 1 is a perspective view illustrating a part of an image-forming apparatus according to a first embodiment of the invention.

FIG. 2 is a cross-sectional view taken along line II-II in FIG. 1.

FIGS. 3A and 3B are cross-sectional views illustrating the layouts of a converging lens array.

FIGS. 4A and 4B illustrate an example of the dimensions of a light-transmitting member and the tilting angle of a slope. FIG. 4A is a plan view of the light-transmitting member viewed from the top, and FIG. 4B is a cross-sectional view of the light-transmitting member viewed from a side.

FIG. 5 illustrates the correspondence between the tilting angle of the converging lens array and the electrical energy ratio.

FIG. 6 is a perspective view illustrating a part of an image-forming apparatus according to a second embodiment of the invention.

FIG. 7 is a cross-sectional view taken along line VII-VII in FIG. 6.

FIGS. 8A and 8B are cross-sectional views illustrating the layouts of a converging lens array.

FIG. 9 is a cross-sectional view illustrating an image-forming apparatus using an electro-optical device as linear optical heads.

FIG. 10 is a cross-sectional view illustrating another image-forming apparatus using an electro-optical device as a linear optical head.

### DESCRIPTION OF EXEMPLARY EMBODIMENTS

### First Embodiment

An electro-optical device according to a first embodiment of the invention will now be described with reference to the drawings.

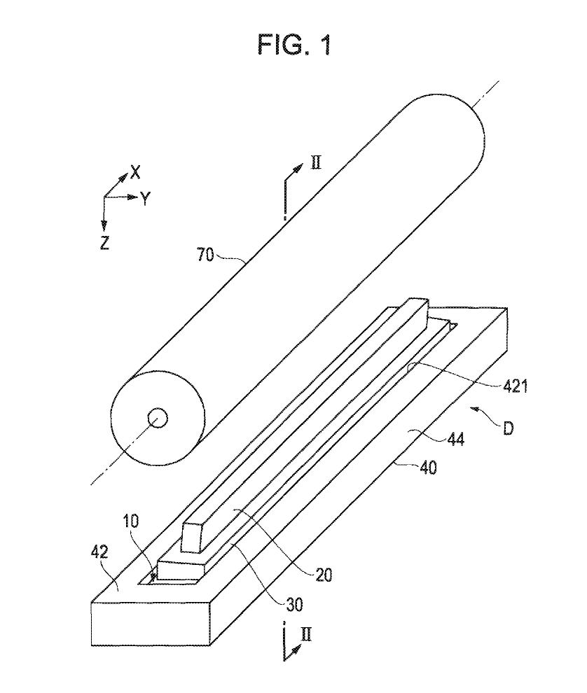

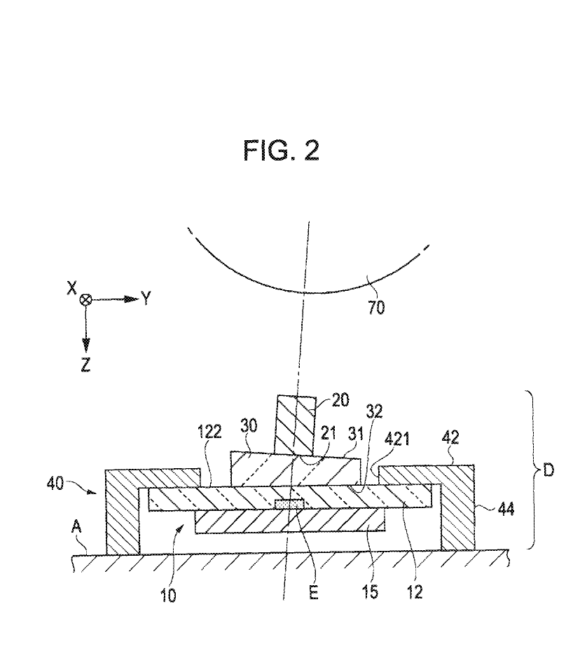

FIG. 1 is a perspective view illustrating a part of an image-forming apparatus according to an embodiment of the invention. FIG. 2 is a cross-sectional view taken along line II-II in FIG. 1. As shown in FIGS. 1 and 2, the image-forming apparatus includes a photosensitive drum 70 and an electro-optical device D. The photosensitive drum 70 is supported by a rotating shaft extending in an X direction, and is rotated while the outer circumferential surface thereof faces the electro-optical device D. The electro-optical device D is mounted on a casing A of the image-forming apparatus as shown in FIG. 2.

As shown in FIGS. 1 and 2, the electro-optical device D includes an electro-optical panel 10, a converging lens array 20, a light-transmitting member 30, and a supporting base 40. The light-transmitting member 30 is disposed between the electro-optical panel 10 and the converging lens array 20.

As shown in FIG. 2, the electro-optical panel 10 includes a rectangular base 12, and is disposed such that the lateral direction of the base 12 is parallel to a Y direction and the longitudinal direction thereof is parallel to the X direction. The base 12 is a plate composed of a light-transmitting material such as glass and plastic. Moreover, a large number of electro-optical elements E are arranged on a first surface of the base 12 (surface facing the casing A) along the X direction. The electro-optical elements E are organic light-emitting diodes including light-emitting layers composed of an organic electroluminescent (EL) material interposed between anodes and cathodes, and independently emit light in response to images instructed to be displayed by external devices. The electro-optical elements E can be arranged in any pattern.

A sealing body 15 is connected to the surface of the base 12 having the electro-optical elements E arranged thereon. The sealing body 15 is an approximately rectangular plate that seals the electro-optical elements E (blocks the electro-optical elements E from outside air) in cooperation with the base 12. This sealing of the electro-optical elements E can suppress the degradation of the electro-optical elements E caused by outside air or water.

The converging lens array 20 is an optical element for converging light beams emitted from the electro-optical elements E, and includes a large number of converging lenses (gradient index lenses) arranged in an array. The converging lens array 20 is disposed such that the lateral direction thereof is parallel to the Y direction and the longitudinal direction thereof is parallel to the X direction. The converging lens array 20 can be, for example, SLA (registered trademark) available from Nippon Sheet Glass Co., Ltd.

The light-transmitting member 30 is composed of a light-transmitting material such as glass and plastic, and allows passage of the light beams emitted from the electro-optical elements E. The light-transmitting member 30 is disposed such that the lateral direction thereof is parallel to the Y direction, and the longitudinal direction thereof is parallel to the X direction. Moreover, as shown in FIG. 2, a slope 31 serving as a first surface (first surface facing the converging lens array 20) of the light-transmitting member 30 is inclined from left to right in FIG. 2, that is, rotated about an axis along which the electro-optical elements E are arranged (X direction) so as not to be parallel to a surface 32 serving as a second surface (second surface facing the base 12) of the light-transmitting member 30. The slope 31 can be inclined from right to left in FIG. 2. The surface 32 is parallel to a drum-opposing surface 122 of the base 12 facing the photosensitive arum 70.

The converging lens array 20 is joined to the light-transmitting member 30 by connecting an incident surface 21 serving as a first end surface (surface facing the light-transmitting member 30) of the converging lens array 20 to the slope 31 of the light-transmitting member 30. With this, the converging lens array 20 is inclined by the same angle as that of the slope 31. Moreover, the electro-optical panel 10 is joined to the light-transmitting member 30 by connecting the drum-opposing surface 122 of the base 12 to the surface 32 of the light-transmitting member 30. In this embodiment, the converging lens array 20, the light-transmitting member 30, and the base 12 are joined using a light-transmitting adhesive.

The supporting base 40 holds the position and the attitude of the electro-optical panel 10. As shown in FIGS. 1 and 2, the supporting base 40 includes a rectangular top portion 42 having an opening 421 corresponding to the outside shape of the light-transmitting member 30 and a frame-shaped side portion 44 extending from the edges of the top portion 42 toward the casing A. The electro-optical panel 10 (to which the light-transmitting member 30 and the converging lens array 20 are joined) is fixed to the supporting base 40 by connecting the drum-opposing surface 122 of the base 12 to a surface of the top portion 42 facing the casing A. Furthermore, the electro-optical panel 10 is fixed to the casing A by connecting the lower end of the side portion 44 to the casing A. The light-transmitting member 30 is located inside the opening 421 when the electro-optical panel 10 is fixed to the supporting base 40.

In the above-described structure, the distance between the drum-opposing surface 122 of the electro-optical panel 10 and the incident surface 21 of the converging lens array 20 is determined by changing the position of the converging lens array 20 on the slope 31 of the light-transmitting member 30 in the tilting direction of the slope 31. That is, the distance between the electro-optical panel 10 and the converging lens array 20 can be changed in accordance with the position of the converging lens array 20 on the slope 31.

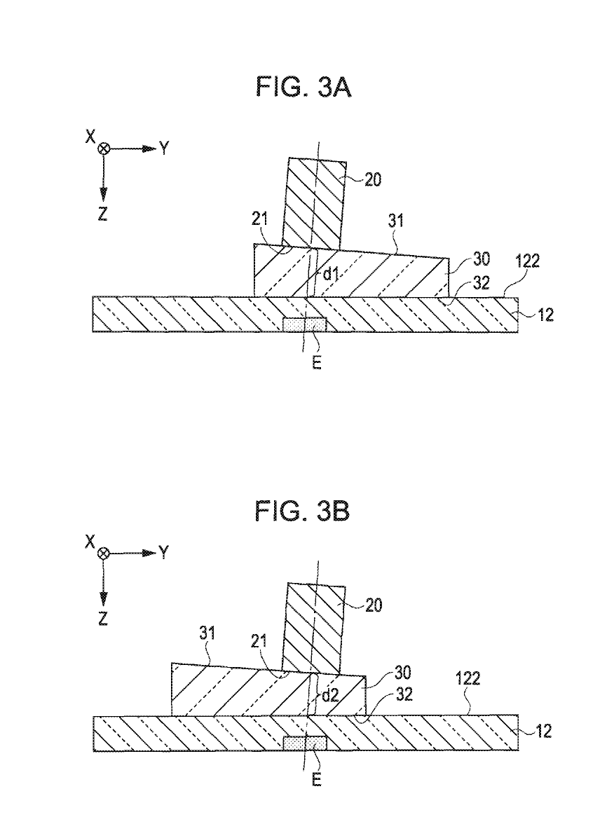

FIGS. 3A and 3B are cross-sectional views illustrating the layouts of the converging lens array 20. In FIG. 3A, the converging lens array 20 is disposed on the slope 31 of the light-transmitting member 30 at the left side (above the center of the slope 31). Moreover, the light-transmitting member 30 is slightly shifted to the right on the drum-opposing surface 122 of the base 12 such that the incident surface 21 of the converging lens array 20 can receive the light beams emitted from the electro-optical elements E. In FIG. 3B, the converging lens array 20 is disposed on the slope 31 at the right side (below the center of the slope 31). Moreover, the light-transmitting member 30 is slightly shifted to the left on the drum-opposing surface 122 such that the incident surface 21 can receive the light beams emitted from the electro-optical elements E. As is clear from the drawings, the distance d1 between the drum-opposing surface 122 and the incident surface 21 shown in FIG. 3A is larger than the distance d2 between the drum-opposing surface 122 and the incident surface 21 shown in FIG. 3B. In this manner, the light-transmitting member 30 functions as a spacer that can be used to variably set the distance between the electro-optical panel 10 and the converging lens array 20 by adjusting the position of the converging lens array 20 on the slope 31 in the tilting direction of the slope 31. In a typical structure, the distance between the electro-optical panel 10 and the converging lens array 20 and that between the converging lens array 20 and the photosensitive drum 70 are approximately one to a few millimeters, and need to be adjusted by approximately −0.1 to +0.1 mm using the light-transmitting member 30. That is, the distance between the electro-optical panel 10 and the converging lens array 20 is preferably adjusted in a range of approximately 0.2 mm using the slope 31 of the light-transmitting member 30.

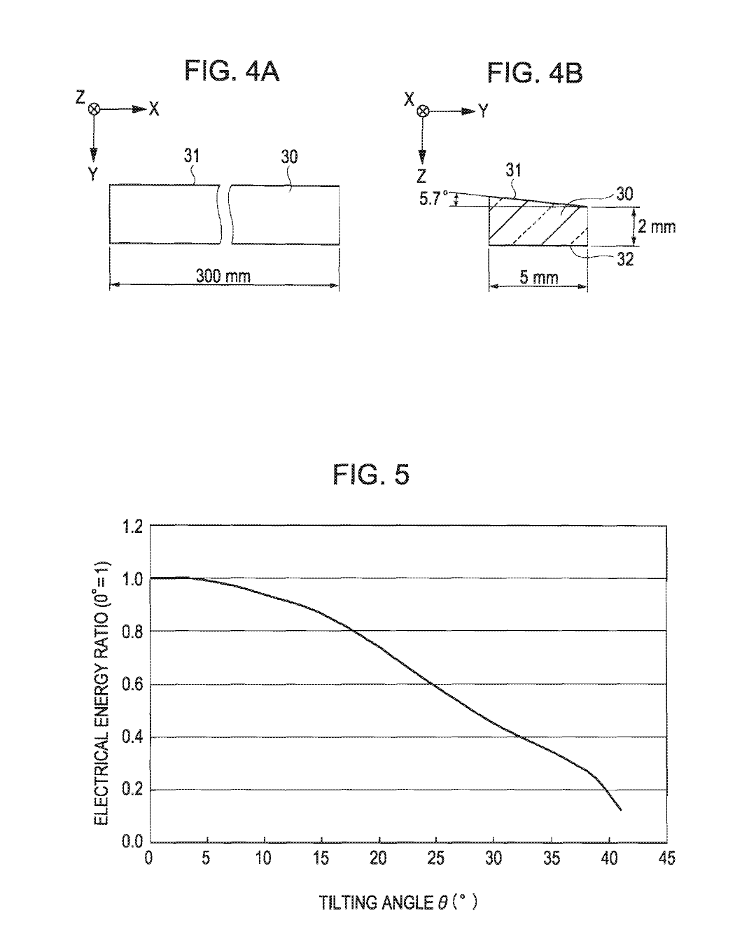

FIGS. 4A and 4B illustrate an example of the dimensions of the light-transmitting member 30 and the tilting angle of the slope 31. FIG. 4A is a plan view of the light-transmitting member 30 viewed from the top (Z direction), and FIG. 4B is a cross-sectional view of the light-transmitting member 30 viewed from a side (X direction). As shown in FIGS. 4A and 4B, the long side and the short side of the light-transmitting member 30 are 300 mm and 5 mm, respectively, and the tilting angle of the slope 31 is 5.7° with respect to the surface 32. When the converging lens array 20 is disposed on the slope 31, the converging lens array 20 is also inclined by 5.7°, and electrical energy input from the electro-optical elements E to the converging lens array 20 can be reduced. FIG. 5 illustrates the correspondence between the tilting angle of the converging lens array 20 and the electrical energy ratio. In FIG. 5, the electrical energy ratio is defined as 1 when the tilting angle is 0°, i.e., the incident surface 21 of the converging lens array 20 is parallel to the drum-opposing surface 122 of the electro-optical panel 10. As shown in FIG. 5, the electrical energy ratio is reduced as the tilting angle is increased. However, the tilting angle of the light-transmitting member 30 shown in FIG. 4B is 5.7°, and the electrical energy ratio is slightly reduced from 1. Accordingly, latent images can be formed on the photosensitive drum 70 substantially without any problems.

Next, a method for producing the electro-optical device according to this embodiment of the invention will be described. First, the distance d between the drum-opposing surface 122 of the electro-optical panel 10 and the incident surface 21 of the converging lens array 20 is determined on the basis of the refractive index distribution of the converging lenses constituting the converging lens array 20, the refractive index of the light-transmitting member 30, and the like.

Next, the converging lens array 20 is disposed on the light-transmitting member 30 such that the distance between the surface 32 of the light-transmitting member 30 and the center of the incident surface 21 is equal to the distance d by adjusting the position of the incident surface 21 of the converging lens array 20 on the slope 31 of the light-transmitting member 30 in the tilting direction of the slope 31.

Next, the converging lens array 20 is joined to the light-transmitting member 30 by connecting the incident surface 21 to the slope 31.

Next, the position of the surface 32 on the drum-opposing surface 122 is determined such that the incident surface 21 receives the light beams emitted from the electro-optical elements E, and the light-transmitting member 30 is joined to the electro-optical panel 10 by connecting the surface 32 to the drum-opposing surface 122 at this position. In this manner, the electro-optical device D is produced. The sequence of the production method is not limited to this, and, for example, the electro-optical panel 10 and the light-transmitting member 30 can be joined to each other first, and the converging lens array 20 and the light-transmitting member 30 can be joined to each other after the position of the incident surface 21 of the converging lens array 20 and the position of the surface 32 on the drum-opposing surface 122 are determined.

The electro-optical device D after completion is fixed to the casing A of the image-forming apparatus. At this moment, the electro-optical device D is disposed such that the direction along which the electro-optical elements E are arranged is parallel to the rotating shaft of the photosensitive drum 70.

As described above, the electro-optical device D according to this embodiment includes the electro-optical panel 10, the converging lens array 20, the light-transmitting member 30, and the supporting base 40; and the light-transmitting member 30 is disposed between the electro-optical panel 10 and the converging lens array 20. The slope 31 of the light-transmitting member 30 facing the incident surface 21 of the converging lens array 20 is inclined from left to right in the example shown in FIG. 2. With this structure, the distance between the drum-opposing surface 122 of the electro-optical panel 10 and the incident surface 21 of the converging lens array 20 can be adjusted by changing the position of the incident surface 21 on the slope 31 in the tilting direction of the slope 31 when the converging lens array 20 is joined to the light-transmitting member 30. For example, the distance between the drum-opposing surface 122 and the incident surface 21 is increased in the example shown in FIG. 3A including the converging lens array 20 at an upper position on the slope 31 as compared with the example shown in FIG. 3B including the converging lens array 20 at a lower position on the slope 31. With this, the distance between the drum-opposing surface 122 and the incident surface 21 can be determined on the basis of the optical characteristics of the components such as the converging lens array 20; and the electro-optical panel 10, the light-transmitting member 30, and the converging lens array 20 can be joined to each other at the positions corresponding to the distance. Thus, an electro-optical device including the electro-optical panel 10, the converging lens array 20, and the light-transmitting member 30 interposed between the electro-optical panel 10 and the converging lens array 20 in an optimum positional relationship can be realized.

### Second Embodiment

Next, an electro-optical device according to a second embodiment of the invention will be described with reference to the drawings. In this embodiment, the same reference numbers are used for components similar to those in the first embodiment, and the description thereof will be omitted as appropriate.

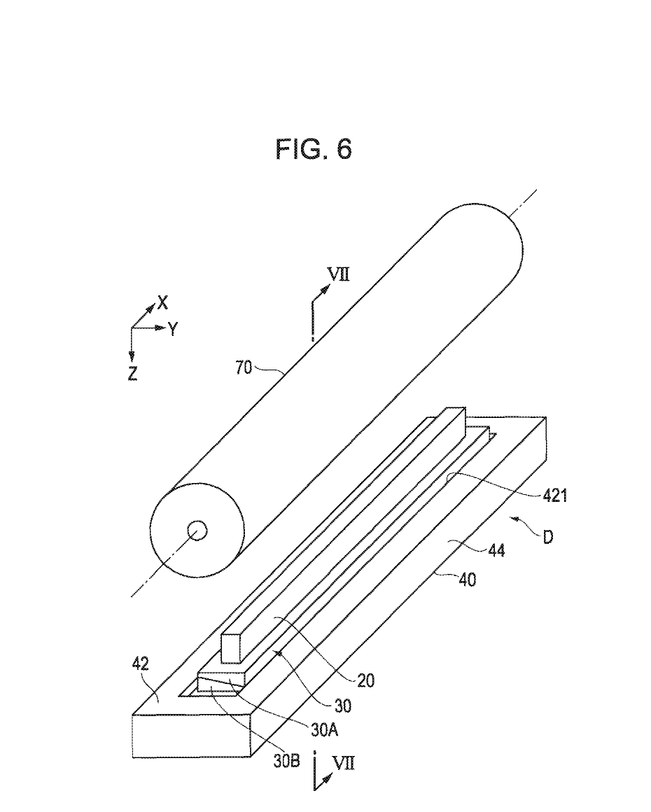

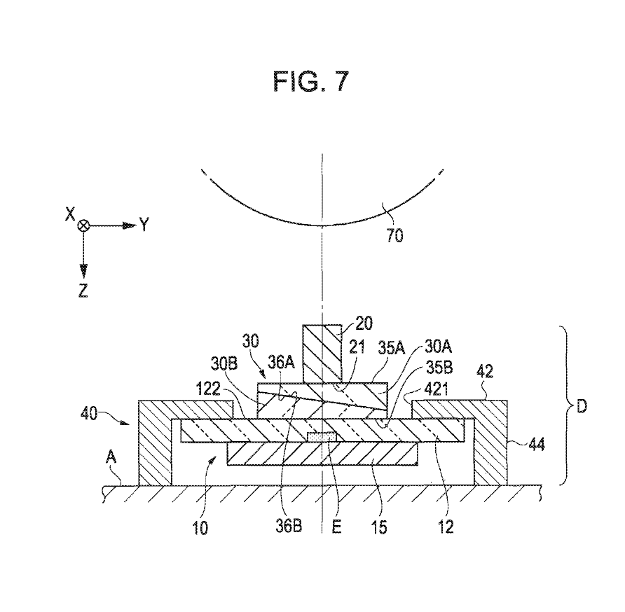

FIG. 6 is a perspective view illustrating a part of an image-forming apparatus according to an embodiment of the invention. FIG. 7 is a cross-sectional view taken along line VII-VII in FIG. 6. As shown in FIGS. 6 and 7, the light-transmitting member 30 includes two approximately wedge-shaped members, i.e., a light-transmitting member 30A (first light-transmitting member) located adjacent to the photosensitive drum 70 and a light-transmitting member 30B (second light-transmitting member) located adjacent to the electro-optical panel 10, disposed on each other unlike the first embodiment. As shown in FIG. 7, the light-transmitting members 30A and 30B face each other, and are in contact with each other at the corresponding slopes 36A and 36B. The slopes 36A and 36B are parallel to each other, and are inclined from left to right in FIG. 7, i.e., rotated about the axis along which the electro-optical elements are arranged. The slopes 36A and 36B can be inclined from right to left in FIG. 7.

The light-transmitting members 30A and 30B are joined to each other at the corresponding slopes 36A and 36B so as to form the light-transmitting member 30. The converging lens array 20 and the light-transmitting member 30 are joined to each other at the incident surface 21 of the converging lens array 20 and a surface 35A (surface facing the converging lens array 20) of the light-transmitting member 30A. With this structure, the converging lens array 20 is disposed parallel to the base 12 of the electro-optical panel 10 unlike the first embodiment. Moreover, the electro-optical panel 10 and the light-transmitting member 30 are joined to each other at the drum-opposing surface 122 of the base 12 and a surface 35B (surface facing the base 12) of the light-transmitting member 30B.

In the above-described structure, the distance between the drum-opposing surface 122 of the electro-optical panel 10 and the incident surface 21 of the converging lens array 20 is determined by the overlapping positions of the slopes 36A and 36B of the light-transmitting members 30A and 30B, respectively, facing each other. That is, the distance between the electro-optical panel 10 and the converging lens array 20 can be changed in accordance with the overlapping positions of the slopes 36A and 36B.

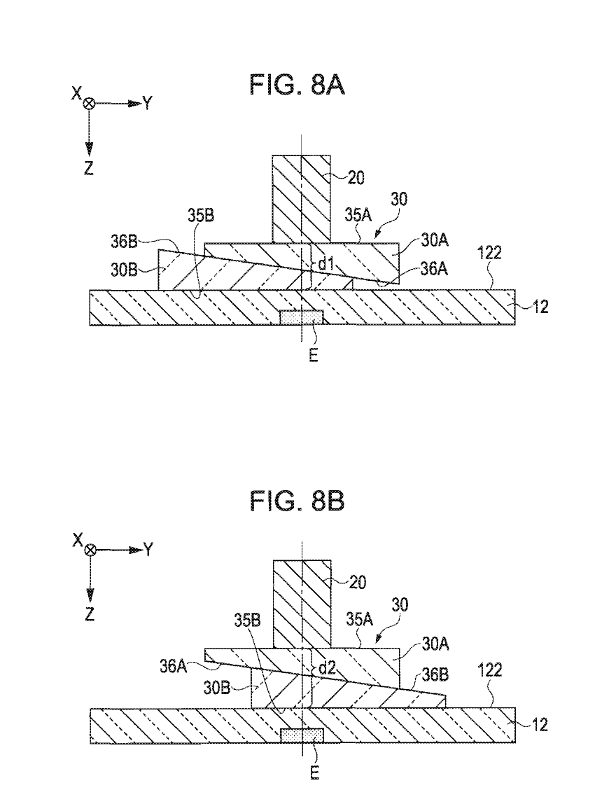

FIGS. 8A and 8B are cross-sectional views illustrating the layouts of the converging lens array 20. In FIG. 8A, the light-transmitting member 30A is slightly shifted to the right with respect to the light-transmitting member 30B. In FIG. 8B, the light-transmitting member 30A is slightly shifted to the left with respect to the light-transmitting member 30B. Herein, the distance d1 between the drum-opposing surface 122 and the incident surface 21 shown in FIG. 8A is smaller than the distance d2 between the drum-opposing surface 122 and the incident surface 21 shown in FIG. 8B. In this manner, the overlapping positions of the light-transmitting members 30A and 30B of the light-transmitting member 30 can be changed in the tilting direction of the slope 31 such that the surface 35A (surface facing the converging lens array 20) of the light-transmitting member 30A is moved in the vertical direction (Z direction). Thus, the light-transmitting member 30 functions as a spacer that can be used to variably set the distance between the electro-optical panel 10 and the converging lens array 20.

In this embodiment, the two light-transmitting members 30A and 30B have approximately the same shape. Therefore, a reduction in strength of the entire light-transmitting member 30 can be regulated even when the positions of the light-transmitting members 30A and 30B are shifted while the light-transmitting members 30A and 30B are overlapped with each other as compared with the case where the two members do not have approximately the same shape. Since the surface 35A of the light-transmitting member 30A is parallel to the electro-optical panel 10, the converging lens array 20 connected to the surface 35A is also parallel to the electro-optical panel 10. Thus, the positions of the electro-optical device D and the photosensitive drum 70 can be easily adjusted.

Next, a method for producing the electro-optical device according to this embodiment of the invention will be described. First, the distance d between the drum-opposing surface 122 of the electro-optical panel 10 and the incident surface 21 of the converging lens array 20 is determined on the basis of the refractive index distribution of the converging lenses constituting the converging lens array 20, the refractive index of the light-transmitting member 30, and the like.

Next, the light-transmitting members 30A and 30B are disposed such that the distance between the surface 35B (surface facing the electro-optical panel 10) of the light-transmitting member 30B and the surface 35A of the light-transmitting member 30A is equal to the distance d by adjusting the overlapping positions of the light-transmitting members 30A and 30B. Subsequently, the light-transmitting members 30A and 30B are joined to each other so as to form the light-transmitting member 30.

Next, the converging lens array 20 is joined to the light-transmitting member 30 by connecting the incident surface 21 to the surface 35A. At this moment, the incident surface 21 is connected to the central portion of the surface 35A.

Next, the position of the surface 35B on the drum-opposing surface 122 is determined such that the incident surface 21 receives the light beams emitted from the electro-optical elements E, and the light-transmitting member 30 is joined to the electro-optical panel 10 by connecting the surface 35B to the drum-opposing surface 122 at this position. In this manner, the electro-optical device D is produced. The sequence of the production method is not limited to this, and, for example, the electro-optical panel 10 and the light-transmitting member 30 can be joined to each other first, and the converging lens array 20 and the light-transmitting member 30 can be joined to each other after the light-transmitting members 30A and 30B are joined to each other.

As described above, the electro-optical device D according to this embodiment includes the electro-optical panel 10, the converging lens array 20, the light-transmitting member 30, and the supporting base 40; and the light-transmitting member 30 formed by overlapping the light-transmitting members 30A and 30B with each other is disposed between the electro-optical panel 10 and the converging lens array 20. The slopes 36A and 36B of the light-transmitting members 30A and 30B, respectively, are inclined from left to right in the example shown in FIG. 7, and are in contact with each other. With this structure, the thickness of the light-transmitting member 30 formed by overlapping the light-transmitting members 30A and 30B with each other can be adjusted by changing the overlapping positions of the slopes 36A and 36B. For example, in FIG. 8A, the slopes 36A and 36B are shifted such that the thickness of the light-transmitting member 30 is reduced. In FIG. 8B, the slopes 36A and 36B are shifted such that the thickness of the light-transmitting member 30 is increased. With this, the distance between the drum-opposing surface 122 and the incident surface 21 can be determined on the basis of the optical characteristics of the components such as the converging lens array 20, and the light-transmitting members 30A and 30B can be joined to each other such that the thickness of the light-transmitting member 30 becomes equal to the determined distance by adjusting the overlapping positions of the light-transmitting members 30A and 30B. Thus, an electro-optical device including the electro-optical panel 10, the converging lens array 20, and the light-transmitting member 30 interposed between the electro-optical panel 10 and the converging lens array 20 in an optimum positional relationship can be realized.

### Third Embodiment

Next, an image-forming apparatus according to a third embodiment of the invention will be described with reference to the drawings. The electro-optical device D according to the above-described embodiments can be used as linear optical heads for forming latent images on image-bearing members in image-forming apparatuses of the electrophotographic type. Such image-forming apparatuses can include printers, printing units of copiers, and printing units of facsimiles.

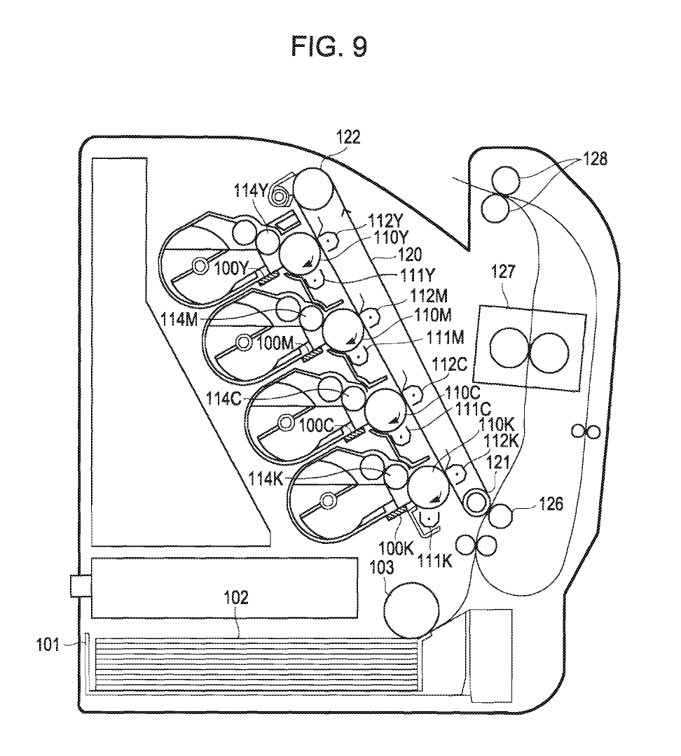

FIG. 9 is a cross-sectional view illustrating an image-forming apparatus using the electro-optical device D according to the above-described embodiments as linear optical heads. The image-forming apparatus is a full-color image-forming apparatus of the tandem type using an intermediate transfer belt.

This image-forming apparatus includes four organic-EL-array exposure heads 100 (100K, 100C, 100M, and 100Y) having the same structure disposed at exposure positions of corresponding photosensitive drums (image-bearing members) 110 (110K, 110C, 110M, and 110Y) having the same structure. The exposure heads 100 each correspond to the electro-optical device D according to the above-described embodiments.

As shown in FIG. 9, the image-forming apparatus includes a driving roller 121, a driven roller 122, and an endless intermediate transfer belt 120 wound around and rotated around the driving roller 121 and the driven roller 122 in the direction of an arrow shown in FIG. 9. Although not shown, the image-forming apparatus can further include tensioners such as tension rollers for applying tension to the intermediate transfer belt 120.

The four photosensitive drums 110 having photosensitive layers formed on the outer circumferential surfaces thereof are disposed adjacent to the intermediate transfer belt 120 with a predetermined spacing therebetween. Characters K, C, M, and Y added to the reference numbers indicate black, cyan, magenta, and yellow, respectively; and components with these characters are used for forming developed images of the corresponding colors. The photosensitive drums 110 are rotated in synchronization with the drive of the intermediate transfer belt 120.

Corona-charging units 111 (111K, 111C, 111M, and 111Y), the exposure heads 100, and developing units 114 (114K, 114C, 114M, and 114Y) are disposed around the photosensitive drums 110. The corona-charging units 111 uniformly charge the outer circumferential surfaces of the corresponding photosensitive drums 110. The exposure heads 100 form electrostatic latent images on the charged outer circumferential surfaces of the photosensitive drums. The exposure heads 100 are disposed such that the direction along which the electro-optical elements E are arranged becomes parallel to the center lines (extending in a main scanning direction) of the photosensitive drums 110. Electrostatic latent images are formed by applying light beams emitted from the electro-optical elements E to the photosensitive drums. The developing units 114 form developed images, i.e., visible images on the photosensitive drums by applying toners serving as developers to the electrostatic latent images.

The developed images of black, cyan, magenta, and yellow formed at these four single-color-image forming stations are successively transferred to the intermediate transfer belt 120 (primary transfer), and superposed on the intermediate transfer belt 120. In this manner, full-color developed images are formed. Four primary-transfer corotrons (transferring units) 112 (112K, 112C, 112M, and 112Y) are disposed inside the intermediate transfer belt 120. The primary-transfer corotrons 112 are disposed adjacent to the corresponding photosensitive arums 110, and transfer developed images to the intermediate transfer belt 120 passing between the photosensitive drums and the primary-transfer corotrons by electrostatically attracting the developed images from the photosensitive drums 110.

Sheets 102 serving as objects on which images are finally formed are fed from a paper-feeding cassette 101 by a pickup roller 103 one by one, and sent to a nip formed between the intermediate transfer belt 120 and a secondary-transfer roller 126, the intermediate transfer belt 120 being in contact with the driving roller 121 at the nip. The full-color developed images formed on the intermediate transfer belt 120 are transferred to first sides of the sheets 102 by the secondary-transfer roller 126 (secondary transfer) in single steps, and fixed on the sheets 102 while the sheets 102 pass through a fixing roller pair 127 serving as a fixing unit. Subsequently, the sheets 102 are ejected to a paper-ejecting cassette formed at an upper portion of the apparatus by a paper-ejecting roller pair 128.

The image-forming apparatus shown in FIG. 9 includes the electro-optical device D using an organic EL array, which includes the electro-optical panel 10, the converging lens array 20, and the light-transmitting member 30 interposed between the electro-optical panel 10 and the converging lens array 20 in an optimum positional relationship as described above, as a writing unit.

### Fourth Embodiment

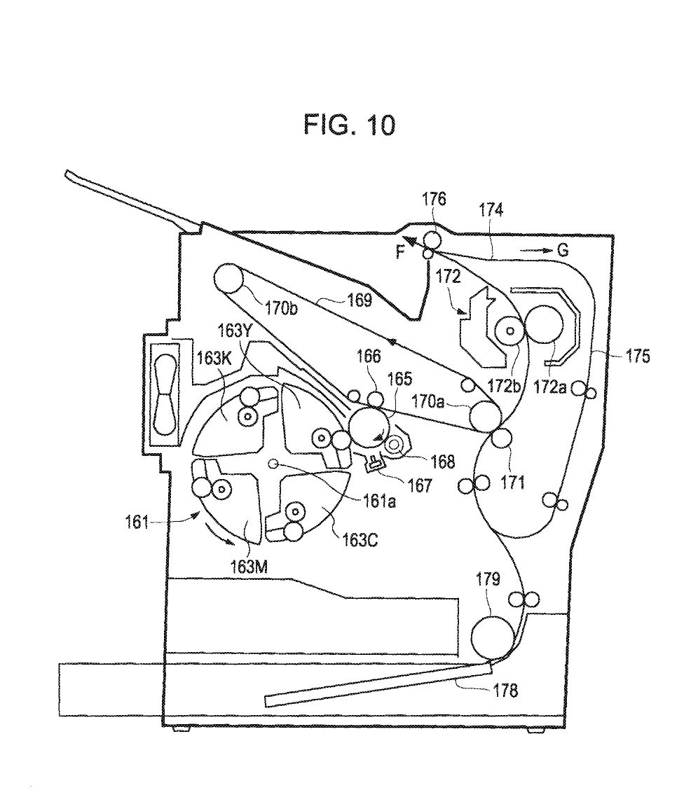

Next, an image-forming apparatus according to a fourth embodiment of the invention will be described with reference to the drawings. FIG. 10 is a cross-sectional view illustrating another image-forming apparatus using the electro-optical device D according to the above-described embodiments as a linear optical head. The image-forming apparatus is a full-color image-forming apparatus of the rotary type using an intermediate transfer belt. In the image-forming apparatus shown in FIG. 10, a corona-charging unit 168, a rotary developing unit 161, an organic-EL-array exposure head 167, and an endless intermediate transfer belt 169 are disposed around a photosensitive drum (image-bearing member) 165.

The corona-charging unit 168 uniformly charges the outer circumferential surface of the photosensitive drum 165. The exposure head 167 forms electrostatic latent images on the charged outer circumferential surface of the photosensitive drum 165. The exposure head 167, which corresponds to the electro-optical device D according to the above-described embodiments, is disposed such that the direction along which the electro-optical elements E are arranged becomes parallel to the center line (extending in a main scanning direction) of the photosensitive drum 165. Electrostatic latent images are formed by applying light beams emitted from the electro-optical elements E to the photosensitive drum.

The developing unit 161 includes four developing devices 163Y, 163C, 163M, and 163K disposed at angular intervals of 90°, and is rotatable in the counterclockwise direction around a shaft 161a. The developing devices 163Y, 163C, 163M, and 163K form developed images, i.e., visible images on the photosensitive drum 165 by supplying toners of yellow, cyan, magenta, and black, respectively, serving as developers to the electrostatic latent images on the photosensitive drum 165.

The intermediate transfer belt 169 is wound around a driving roller 170a, a driven roller 170b, a primary-transfer roller 166, and tension rollers; and is rotated around these rollers in the direction of an arrow shown in FIG. 10. The primary-transfer roller 166 transfers developed images to the intermediate transfer belt 169 passing between the photosensitive drum 165 and the primary-transfer roller 166 by electrostatically attracting the developed images from the photosensitive drum 165.

More specifically, an electrostatic latent image for yellow is formed by the exposure head 167, a developed image of yellow is formed by the developing device 163Y, and the developed image is transferred to the intermediate transfer belt 169 during a first rotation of the photosensitive drum 165. During the next rotation, an electrostatic latent image for cyan is formed by the exposure head 167, a developed image of cyan is formed by the developing device 163C, and the developed image is transferred to the intermediate transfer belt 169 and superposed on the developed image of yellow. While the photosensitive drum 165 is rotated four times, the developed images of yellow, cyan, magenta, and black are successively superposed on the intermediate transfer belt 169. In this manner, a full-color developed image is formed on the intermediate transfer belt 169. When images are to be formed on both sides of sheets serving as objects on which images are finally formed, developed images of the same color for the front side and the back side are transferred to the intermediate transfer belt 169, and subsequently, developed images of the next color for the front side and the back side are transferred to the intermediate transfer belt 169. In this manner, full-color developed images are formed on the intermediate transfer belt 169.

The image-forming apparatus has a sheet-transporting path 174 along which sheets are transported. The sheets are taken out of a paper-feeding cassette 178 by a pickup roller 179 one by one, are fed along the sheet-transporting path 174 by transporting rollers, and pass through a nip formed between the intermediate transfer belt 169 and a secondary-transfer roller 171, the intermediate transfer belt 169 being in contact with the driving roller 170a at the nip. The secondary-transfer roller 171 transfers the developed images to first sides of the sheets by electrostatically attracting the full-color developed images from the intermediate transfer belt 169 in single steps. The secondary-transfer roller 171 can be brought into contact with or be separated from the intermediate transfer belt 169 by a clutch (not shown). The secondary-transfer roller 171 is in contact with the intermediate transfer belt 169 while the full-color developed images are transferred to the sheets, and is separated from the intermediate transfer belt 169 while developed images are superposed on the intermediate transfer belt 169.

The sheets to which the images have been transferred are transported to a fixing unit 172, and pass between a heating roller 172a and a pressurizing roller 172b of the fixing unit 172 such that the developed images transferred to the sheets are fixed on the sheets. The sheets after the fixing process are drawn by paper-ejecting rollers 176 and are moved in the direction of an arrow F. In the case of two-sided printing, the paper-ejecting rollers 176 are rotated in the reverse direction after most part of the sheets is passed through the paper-ejecting rollers 176, and the sheets are guided to a transporting path 175 for two-sided printing in the direction of an arrow G. The developed images are transferred to second sides of the sheets by the secondary-transfer roller 171, and fixed at the fixing unit 172 again. Subsequently, the sheets are ejected by the paper-ejecting rollers 176.

The image-forming apparatus shown in FIG. 10 includes the exposure head 167 (electro-optical device D) using an organic EL array, which includes the electro-optical panel 10, the converging lens array 20, and the light-transmitting member 30 interposed between the electro-optical panel 10 and the converging lens array 20 in an optimum positional relationship as described above, as a writing unit.

Examples of image-forming apparatuses to which the electro-optical device D according to the above-described embodiments is applicable have been described above. The electro-optical device according to the above-described embodiments can be applied to other image-forming apparatuses of the electrophotographic type, and such image-forming apparatuses are encompassed within the scope of the invention. The electro-optical device can be applied to, for example, image-forming apparatuses in which developed images are directly transferred from photosensitive drums to sheets without using intermediate transfer belts and image-forming apparatuses that form monochromatic images.

### First Modification

In the above-described embodiments, the converging lens array 20, the light-transmitting member 30 (light-transmitting members 30A and 30B in the second embodiment), and the electro-optical panel 10 are joined to each other using adhesives. The invention is not limited to this, and part of or all these components can be independently supported by the supporting base 40 or other components.

### Second Modification

In the above-described embodiments, organic light-emitting diodes, serving as light-emitting elements that convert electrical energy into optical energy, are used in the electro-optical panel 10. The invention is not limited to this, and inorganic EL elements, field-emission (FE) elements, surface-conduction electron-emitter (SE) elements, ballistic-electron surface-emitting (BS) elements, light-emitting diodes (LEDs), liquid-crystal elements, electrophoretic elements, electrochromic elements, and the like can be used as the electro-optical elements. Moreover, the electro-optical panel 10 can be of the top emission type or of the bottom emission type.

### Third Modification

In the image-forming apparatus according to the above-described embodiments, the electro-optical device D is used for exposure of the image-bearing members to light. However, the invention is not limited to this, and the electro-optical device D can be applied to, for example, image-reading apparatuses as linear optical heads (illuminating devices) that illuminate objects to be read such as original documents. Image-reading apparatuses of this type can include scanners, reading units of copiers and facsimiles, barcode readers, and image code readers that read two-dimensional codes such as QR codes (registered trademark).

The entire disclosure of Japanese Patent Application No. 2007-002041, filed Jan. 10, 2007 is expressly incorporated by reference herein.

What is claimed is:

1. An electro-optical device comprising:
an electro-optical panel including a substrate and a plurality of electro-optical elements arranged on the substrate;
a converging lens that converges a light beam emitted from the electro-optical panel; and
a light-transmitting member interposed between the electro-optical panel and the converging lens, wherein
a first surface of the light-transmitting member opposing the converging lens is rotated about an axis along which the electro-optical elements are arranged on the substrate.

2. The electro-optical device according to claim 1, wherein
the converging lens is joined to the light-transmitting member at the first surface of the light-transmitting member, and
the electro-optical panel is joined to the light-transmitting member at a second surface of the light-transmitting member opposing the electro-optical panel.

3. The electro-optical device according to claim 1, wherein the position of the converging lens is adjusted on the first surface of the light-transmitting member in the tilting direction of the first surface.

4. An electro-optical device comprising:
an electro-optical panel including a substrate and a plurality of electro-optical elements arranged on the substrate;
a converging lens that converges a light beam emitted from the electro-optical panel; and
a first light-transmitting member and a second light-transmitting member interposed between the electro-optical panel and the converging lens, wherein
a first surface of the first light-transmitting member opposing the second light-transmitting member and a first surface of the second light-transmitting member opposing the first light-transmitting member are parallel to each other, and are rotated about an axis along which the electro-optical elements are arranged on the substrate.

5. The electro-optical device according to claim 4, wherein
the first and second light-transmitting members are joined to each other at the first surfaces thereof,
the converging lens is joined to the first light-transmitting member at a second surface of the first light-transmitting member opposing the converging lens, and
the electro-optical panel is joined to the second light-transmitting member at a second surface of the second light-transmitting member opposing the electro-optical panel.

6. The electro-optical device according to claim 4, wherein the positions of the first and second light-transmitting members are adjusted by changing the contact positions of the first surfaces of the first and second light-transmitting members in the tilting direction of the first surfaces.

7. The electro-optical device according to claim 4, wherein the cross sections of the first and second light-transmitting members orthogonal to the axis along which the electro-optical elements are arranged are substantially the same.

8. The electro-optical device according to claim 4, wherein the cross sections of the first and second light-transmitting members orthogonal to the axis along which the electro-optical elements are arranged are substantially wedge-shaped,

9. An image-forming apparatus comprising:
an image-bearing member on which a latent image is formed when the image-bearing member is exposed to light;
the electro-optical device according to claim 1 exposing the image-bearing member to light; and
a developing unit that forms a developed image by applying a developer to the latent image on the image-bearing member.

10. A method for producing the electro-optical device according to claim 1, comprising:
adjusting the position of the converging lens on the first surface of the light-transmitting member in the tilting direction of the first surface;
joining the converging lens to the light-transmitting member at the first surface of the light-transmitting member; and
joining the electro-optical panel to the light-transmitting member at a second surface of the light-transmitting member opposing the electro-optical panel.

11. A method for producing the electro-optical device according to claim 4, comprising:
adjusting the positions of the first and second light-transmitting members by changing the contact positions of the first surfaces of the first and second light-transmitting members in the tilting direction of the first surfaces;
joining the first and second light-transmitting members to each other at the first surfaces thereof;
joining the converging lens to the first light-transmitting member at a second, surface of the first light-transmitting member opposing the converging lens; and
joining the electro-optical panel to the second light-transmitting member at a second surface of the second light-transmitting member opposing the electro-optical panel.
